(19) United States
(12) Patent Application Publication
(10) Pub. No.: US 2018/0151105 A1
(43) Pub. Date: May 31, 2018

(54) DISPLAY DRIVER, DISPLAY, AND MOBILE TERMINAL

(71) Applicant: Wuhan China Star Optoelectronics Technology Co., Ltd., Wuhan, Hubei (CN)

(72) Inventors: Taisheng AN, Shenzhen, Guangdong (CN); Jinjie ZHOU, Shenzhen, Guangdong (CN)

(73) Assignee: Wuhan China Star Optoelectronics Technology Co., L td., Wuhan, Hubei (CN)

(21) Appl. No.: 15/118,876

(22) PCT Filed: Jun. 21, 2016
(86) PCT No.: PCT/CN2016/086638

§ 371 Date: Aug. 13, 2016

(30) Foreign Application Priority Data
May 26, 2016 (CN) 201610355615.5

(51) Int. Cl. G09G 3/20; G09G 3/36

(52) U.S. Cl. CPC G09G 3/2096; G09G 3/3688; G09G 3/3696; H04W 52/0209; G09G 2320/0276; G09G 2320/0646; G09G 2310/027; G09G 2330/021

(57) ABSTRACT

The present disclosure teaches a display driver processing image data delivered from a processor of a terminal. The display driver includes a data receiver, a bit-width memory, an image processing module, an image data latch, a digital-to-analog (D/A) conversion module, a gamma correction module, a voltage module, a pulse width modulation module, and an image analog data output module. The display driver further includes a control module activated by the processor to detect whether the bit-width memory is turned on. If the bit-width memory is on, the control module turns off the image processing and gamma correction modules. The voltage module provides grey-level voltages for the D/A conversion module according to and corresponding to the image data delivered from the bit-width memory to the image data latch. The image analog data output module is for receiving and outputting the analog signals.

### CROSS REFERENCE

This application claims the priority of Chinese Patent Application No. 201610355615.5, entitled “Display driver, display, and mobile terminal”, filed on May 26, 2016, the disclosure of which is incorporated herein by reference in its entirety.

### FIELD OF THE INVENTION

The present disclosure relates to display technologies, and more particularly to a display driver, and a display and a mobile terminal employing the driver.

### BACKGROUND OF THE INVENTION

Smart phones are gaining widespread popularly in recent years. As the smart phones are getting even more powerful, their power consumption also significantly increases. A smart phone's display is responsible for a major part of power consumption. One way to reduce power consumption is to configure integrated latches in the display driver. Dynamic image data is delivered to the display driver from the smart phone's application processor. The driver's data receiver converts the received data into RGB signals and stores the signals in the integrated latches. However, for the display driver to show an image, data accessed from the latches still have to be stored in random access memory (RAM) for processing such as color enhancement, dynamic backlight control, etc. These will still consume a certain amount of the electricity.

### SUMMARY OF THE INVENTION

An objective of the present disclosure is to provide a display driver whose power consumption can be effectively reduced.

The present disclosure also provides a display and a terminal.

The display driver is for a terminal and includes a data receiver, a bit-width memory, an image processing module, an image data latch, a digital-to-analog (D/A) conversion module, a gamma correction module, a voltage module, a control module, and an image analog data output module.

The data receiver receives image data and commands related to the content of the image data from a processor of the terminal.

The bit-width memory receives the image data from the data receiver.

The image processing module processes the image data from the bit-width memory.

The image data latch stores the image data processed by the image processing module, or the image data from the data receiver.

The D/A conversion module receives the image data from the image data latch and converts the image data to analog signals.

The gamma correction module adjusts voltage values of the image data from the image data latch and sends to the D/A conversion module.

The control module is activated by the commands from the processor to detect whether the bit-width memory is turned on or not; If the bit-width memory is found to be on, the control module turns off the image processing module and the gamma correction module.

The voltage module provides reference voltages to the gamma correction module and grey-level voltages for the D/A conversion module according to and corresponding to the image data delivered from the bit-width memory to the image data latch.

The image analog data output module is for receiving and outputting the analog signals.

The commands turns on or off the bit-width memory, and activates the control module to conduct detection; and, when the control module detects that the bit-width memory is turned off, the control module does not perform any work.

The image data sent from the processor includes grey-levels 0 and 255; and the commands associated with the grey-levels 0 and 255 turns on the bit-width memory.

The image processing module includes a color enhancing module and a dynamic backlight adjustment module; the color enhancing module enhances the color gamut of the image data delivered from the data receiver; and the dynamic backlight adjustment module adjusts the grey levels of the image data processed by the color enhancing module, and produces corresponding backlight adjustment signals.

The display driver further includes a pulse width modulation module for adjusting backlight adjustment signals produced by the image processing module.

The D/A conversion module includes a voltage selection switch for working with grey-level voltages with grey-level 0 or 255.

The display driver further includes a level conversion module for raising the voltages of the image data output from the image data latch.

The data receiver has a Mobile Industry Processor Interface (MIPI) port.

The display of the present disclosure includes a display panel and a display driver as described above. The display driver is electrically connected to the display panel.

The terminal of the present disclosure includes a display described above and a main board. The main board is configured with a processor. The processor is connected to the display driver so as to drive the display.

The display driver of the present disclosure adopts a specification complying data receiver and, through the configuration of the control module, the bit-width memory is detected and the image processing module and the gamma correction module is turned off. When the data receiver receives image data of a single color frame, such as an image having grey-level 0 or 255, the control module turns off the image processing module and the gamma correction module. Compared to the prior art where all image data have to be processed by the image processing module, the teaching of the present disclosure stores image data directly in the image data latch and avoids turning on the image processing module and the gamma correction module, thereby by reducing power consumption of the terminal.

### BRIEF DESCRIPTION OF THE DRAWINGS

In order to more clearly illustrate the embodiments of the present disclosure or prior art, the following figures will be described in the embodiments are briefly introduced. It is obvious that the drawings are merely some embodiments of the present disclosure, those of ordinary skill in this field can obtain other figures according to these figures without paying the premise.

FIG. 1 is a functional block diagram showing a terminal according to an embodiment of the present disclosure.

### DETAILED DESCRIPTION OF PREFERRED EMBODIMENTS

Embodiments of the present disclosure are described in detail with the technical matters, structural features, achieved objects, and effects with reference to the accompanying drawings as follows. It is clear that the described embodiments are part of embodiments of the present disclosure, but not all embodiments. Based on the embodiments of the present disclosure, all other embodiments to those of ordinary skill in the premise of no creative efforts obtained, should be considered within the scope of protection of the present disclosure.

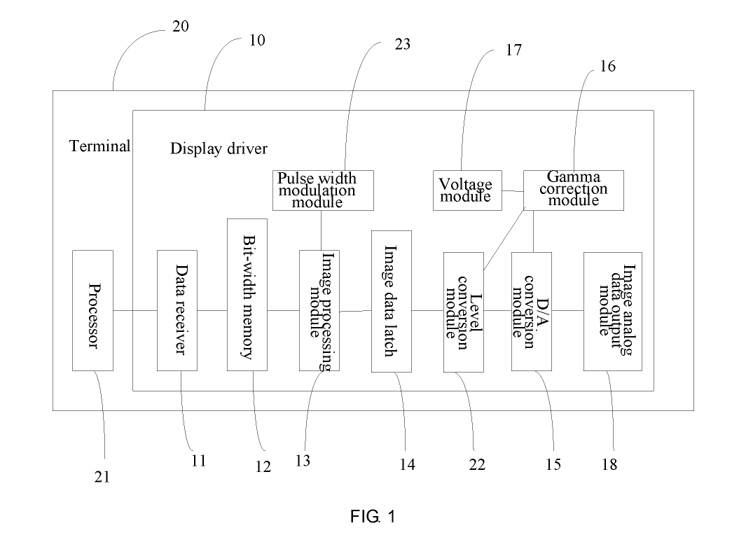

As shown in FIG. 1, the present disclosure teaches a display driver 10, a display, and a terminal 20. The display driver 10 processes image data delivered from a processor of the terminal 20, and drives the display to present images. The display includes a display panel electrically connected to the display driver 10. The display is a liquid crystal display (LCD), and the terminal 20 may be a cellular phone or a monitor. The terminal 20 is a cellular phone in the present embodiment. The terminal 20 includes a main board configured with a processor 21. The processor 21 is connected to the display driver 10 to drive the display driver 10.

In the present embodiment, the display driver 10 includes a data receiver 11, a bit-width memory 12, an image processing module 13, an image data latch 14, a digital-to-analog (D/A) conversion module 15, a gamma correction module 16, a voltage module 17, a pulse width modulation module 23, and an image analog data output module 18.

The data receiver 11 receives image data and commands related to the content of the image data from the processor 21. The image data may include color frame data and mono frame data. The commands control the subsequent operation of the other components on the color frame data or the mono frame data.

The bit-width memory 12 receives image data from the data receiver 11.

The image processing module 13 processes image data from the bit-width memory 12.

The image data latch 14 stores image data processed by the image processing module 13, or image data from the data receiver 11.

The D/A conversion module 15 receives image data from the image data latch 14 and converts the image data to analog signals. The gamma correction module 16 adjusts voltage values of image data from the image data latch 14 and sends to the D/A conversion module 15. The voltage module 17 provides reference voltages to the gamma correction module 16.

The display driver 10 further includes a control module 19 that is activated by the commands from the processor 21 to detect whether the bit-width memory 12 is turned on or not. If the bit-width memory 12 is found to be on, the control module 19 turns off the image processing module 13 and the gamma correction module 16. The voltage module 17 provides grey-level voltages for the D/A conversion module 15 according to and corresponding to the image data delivered from the bit-width memory 12 to the image data latch 14. The image analog data output module 18 is for receiving and outputting the analog signals.

The processor 21 issues commands to turn on or off the bit-width memory 12, and activates the control module 19 to conduct detection. When the control module 19 detects that the bit-width memory 12 is turned off, the control module 19 does not perform any work.

In the present embodiment, the data receiver 11 has a Mobile Industry Processor Interface (MIPI) port capable of receiving image data and commands from the processor 21. When image data from the processor 21 is a single frame, such as a single white or black frame, and the commands turns on the bit-width memory 12. When the bit-width memory 12 is turned on, the control module 19 turns off the image processing module 13 and gamma correction module 16. The image data from the bit-width memory 12 is directly stored in the image data latch 14. The D/A conversion module 15 accesses the image data stored in the image data latch 14 and converts the image data into analog signals. The voltage module 17 provides grey level voltages for the D/A conversion module 15 according to and corresponding to the image data delivered from the bit-width memory 12 to the image data latch 14. The image analog data output module 18 is for receiving and outputting the analog signals. The display driver 10 further includes a level conversion module 22 for raising the voltages of the image data output from the image data latch 14 before the image data enters the D/A conversion module 15.

As described above, the display driver of the present disclosure adopts a specification complying data receiver and, through the configuration of the control module, the bit-width memory is detected and the image processing module and the gamma correction module is turned off. When the data receiver receives image data of a single color frame, such as an image having grey-level 0 or 255, the control module turns off the image processing module and the gamma correction module. Compared to the prior art where all image data have to be processed by the image processing module, the teaching of the present disclosure stores image data directly in the image data latch and avoids turning on the image processing module and the gamma correction module, thereby by reducing power consumption of the terminal.

In the present embodiment, the image data sent from the processor 21 includes grey-levels 0 and 255. The commands associated with the grey-levels 0 and 255 turns on the bit-width memory 12. Image of grey-level 0 or 255 is a single-color image. For multi-color images, the processor 21 turns off the bit-width memory 12. In addition, the D/A conversion module 15 includes a voltage selection switch for working with grey-level voltages with grey-level 0 or 255. Grey-levels 0 and 255 are stored as 0 and 1 in the bit-width memory 12.

In the present embodiment, the image processing module 13 includes a color enhancing module and a dynamic backlight adjustment module. The color enhancing module enhances the color gamut of the image data delivered from the data receiver. The dynamic backlight adjustment module adjusts the grey levels of the image data processed by the color enhancing module, and produces corresponding backlight adjustment signals. The image processing module 13 may further includes white balance adjustment module, image data sharpness enhancement module, etc., which are not shown in FIG. 1.

The pulse-width modulation module 23 adjusts the backlight adjustment signals produced by the image processing module 13.

The display further includes thin-film transistor (TFT) switch elements. The image data output module is connected to the source of the TFT switch elements. The image data delivered by the processor is serial image data, and the serial image data is converted into parallel image data. The image data is video data.

Above are embodiments of the present disclosure, which does not limit the scope of the present disclosure. Any modifications, equivalent replacements or improvements within the spirit and principles of the embodiment described above should be covered by the protected scope of the disclosure.

What is claimed is:

1. A display driver for a terminal, comprising a data receiver, a bit-width memory, an image processing module, an image data latch, a digital-to-analog (D/A) conversion module, a gamma correction module, a voltage module, a control module, and an image analog data output module, wherein
the data receiver receives image data and commands related to the content of the image data from a processor of the terminal;
the bit-width memory receives the image data from the data receiver;
the image processing module processes the image data from the bit-width memory;
the image data latch stores the image data processed by the image processing module, or the image data from the data receiver;
the D/A conversion module receives the image data from the image data latch and converts the image data to analog signals
the gamma correction module adjusts voltage values of the image data from the image data latch and sends to the D/A conversion module;
the control module is activated by the commands from the processor to detect whether the bit-width memory is turned on or not; If the bit-width memory is found to be on, the control module turns off the image processing module and the gamma correction module;
the voltage module provides reference voltages to the gamma correction module and grey-level voltages for the D/A conversion module according to and corresponding to the image data delivered from the bit-width memory to the image data latch; and
the image analog data output module is for receiving and outputting the analog signals.

2. The display driver according to claim 1, wherein the commands turns on or off the bit-width memory, and activates the control module to conduct detection; and, when the control module detects that the bit-width memory is turned off, the control module does not perform any work.

3. The display driver according to claim 1, wherein the image data sent from the processor comprises grey-levels 0 and 255; and the commands associated with the grey-levels 0 and 255 turns on the bit-width memory.

4. The display driver according to claim 1, wherein the image processing module comprises a color enhancing module and a dynamic backlight adjustment module; the color enhancing module enhances the color gamut of the image data delivered from the data receiver; and the dynamic backlight adjustment module adjusts the grey levels of the image data processed by the color enhancing module, and produces corresponding backlight adjustment signals.

5. The display driver according to claim 1, further comprising a pulse width modulation module for adjusting backlight adjustment signals produced by the image processing module.

6. The display driver according to claim 4, further comprising a pulse width modulation module for adjusting the backlight adjustment signals produced by the image processing module.

7. The display driver according to claim 1, wherein the D/A conversion module comprises a voltage selection switch for working with grey-level voltages with grey-level 0 or 255.

8. The display driver according to claim 1, further comprising a level conversion module for raising the voltages of the image data output from the image data latch.

9. The display driver according to claim 1, wherein the data receiver has a Mobile Industry Processor Interface (MIPI) port.

10. A display for a terminal comprising a display panel and a display driver, wherein
the display driver is electrically connected to the display panel and comprises a data receiver, a bit-width memory, an image processing module, an image data latch, a digital-to-analog (D/A) conversion module, a gamma correction module, a voltage module, a control module, and an image analog data output module;
the data receiver receives image data and commands related to the content of the image data from a processor of the terminal;
the bit-width memory receives the image data from the data receiver;
the image processing module processes the image data from the bit-width memory;
the image data latch stores the image data processed by the image processing module, or the image data from the data receiver;
the D/A conversion module receives the image data from the image data latch and converts the image data to analog signals
the gamma correction module adjusts voltage values of the image data from the image data latch and sends to the D/A conversion module;
the control module is activated by the commands from the processor to detect whether the bit-width memory is turned on or not; If the bit-width memory is found to be on, the control module turns off the image processing module and the gamma correction module;
the voltage module provides reference voltages to the gamma correction module and grey-level voltages for the D/A conversion module according to and corresponding to the image data delivered from the bit-width memory to the image data latch; and
the image analog data output module is for receiving and outputting the analog signals.

11. The display according to claim 10, wherein the commands turns on or off the bit-width memory, and activates the control module to conduct detection; and, when the control module detects that the bit-width memory is turned off, the control module does not perform any work.

12. The display according to claim 10, wherein the image data sent from the processor comprises grey-levels 0 and 255; and the commands associated with the grey-levels 0 and 255 turns on the bit-width memory.

13. The display according to claim 10, wherein the image processing module comprises a color enhancing module and a dynamic backlight adjustment module;
the color enhancing module enhances the color gamut of the image data delivered from the data receiver; and the dynamic backlight adjustment module adjusts the grey levels of the image data processed by the color enhancing module, and produces corresponding backlight adjustment signals.

14. The display according to claim 14, wherein the display driver further comprises a pulse width modulation module for adjusting the backlight adjustment signals produced by the image processing module.

15. The display according to claim 10, wherein the D/A conversion module comprises a voltage selection switch for working with grey-level voltages with grey-level 0 or 255.

16. The display according to claim 10, wherein the display driver further comprises a level conversion module for raising the voltages of the image data output from the image data latch.

17. The display according to claim 10, wherein the data receiver has a Mobile Industry Processor Interface (MIPI) port.

18. A terminal comprising a main board and a display as claimed in claim 10, wherein the main board has a processor; and the processor is connected to the display driver to drive the display.
